(19) United States
(12) Patent Application Publication
(10) Pub. No.: US 2009/0285247 A1
(43) Pub. Date: Nov. 19, 2009

(54) OPTICAL APPARATUS COMPRISING A PUMP-LIGHT-GUIDING FIBER

(76) Inventors: Yoav Sintov, Petach Tikva (IL); Raz Gvishi, Gedera (IL); Yaakov Glick, Rehovot (IL); Ori Katz, Moshav Bazra (IL); Galit Strum, Ashkelon (IL); Avraham Englander, Rehovot (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 12/307,361

(22) PCT Filed: Jul. 2, 2007
(86) PCT No.: PCT/IL07/00818

§ 371 Date: Jan. 4, 2009

Related U.S. Application Data
(60) Provisional application No. 60/818,303, filed on Jul. 5, 2006.

(51) Int. Cl. H01S 3/30; H01S 3/00

(52) U.S. Cl. 372/6; 359/341.3

(57) ABSTRACT

Optical apparatus including a pump-guiding fiber (30) including a fiber cladding (31), a fiber core (32) and an attachment section (33), the attachment section (33) including a straight core section (34) and a tapered core section (35), the pump-guiding fiber (30) being optically attached at one end thereof to a pump source (29) and an opposite end of the pump-guiding fiber (30) being attached to an inner clad (42) of a receiving fiber (40) through an attachment section (50), the attachment section (50) including both the straight core section (34) and the tapered core section (35) of the pump-guiding fiber (30), characterized in that both the straight core section (34) and the tapered core section (35) of the pump-guiding fiber (30) are attached to the receiving fiber (40) with an intermediate sol-gel material (51).

The present invention relates to method and materials of implementing side pumping of fiber lasers and amplifiers, such as high power fiber lasers and amplifiers.

### BACKGROUND OF THE INVENTION

High power fiber lasers have become increasingly popular due to their high efficiency, simplicity and reliability. In addition, they may be easily ruggedized, due to their simple arrangement.

High power applications generally use a double clad fiber. This fiber comprises a core, usually doped with a lasing material such as rare earth ions or other, an inner cladding encircling the doped core, through which the pump power flows and is gradually absorbed in the doped core, and an outer cladding encircling the inner cladding and forming a dielectric wave guide for the pump signal. The optical characteristics of the inner cladding closely match high power diode lasers, commonly used for solid-state laser pumping. Therefore, highly efficient pumping may be achieved by utilizing double clad fibers as a gain material.

One of the problems in double clad fibers, used for high power fiber laser applications, is the end pumping approach for injecting optical pump power. End pumping provides at most only two input ends for each fiber in the laser system, through which all the injected power enters the fiber. This physical limit constrains the number and type of pump sources that may be used to inject the optical power. In addition, when the double clad fiber is used as a power amplifier, end pumping prohibits simple injection of the signal to be amplified, and renders the coupling optics cumbersome and expensive.

Modern high power pumping techniques for commercial fiber lasers and amplifiers are usually based on end pumping by diode lasers. The common fibers used for fiber lasers applications are Yb³⁺ doped silica with tunable output between 980 nm-1200 nm (pumped by either 915 nm or 980 nm diodes), Er³⁺ doped silica for 1550 nm eye-safe and communication applications (pumped by either 980 nm or 1480 nm diodes), and Yb³⁺:Er³⁺ silica fibers used also for 1550 nm applications, but in the high power range, where the wide spread erbium doped fibers are not applicable. Other fiber lasers used mostly for 2 μm remote sensing and medical applications are Tm³⁺ doped and Ho³⁺:Tm³⁺ doped silica fibers.

The most commonly used fiber for marking, drilling and other industrial applications is the Yb³⁺ fiber, characterized by high efficiency and robustness. In addition, reliable and efficient pump diodes are available for this ion excitation, while its wide absorption band (25 nm) enables using pump diodes that do not need special cooling. The fiber's high efficiency and high surface-to-volume ratio enables cooling by air rather than cumbersome liquid cooling in solid-state lasers.

One of the main limitations today in using high power fiber lasers and amplifiers is, however, the pump coupling technique. Reference is now made to FIG. 1, which illustrates a prior art end coupling in a high power fiber amplifier. A high power diode 10 may pump optical power to a rare-earth doped double clad fiber 18 (e.g., Yb³⁺ doped fiber), through coupling optics 12 and an end-fiber coupling section 14. A seeder 16, such as a 1.064 μm diode, may inject low power signals to coupling section 14. Coupling section 14 may be coated for anti-reflection at the pump wavelength and may have high reflection at the signal wavelength. The double clad fiber 18 may be connected to output coupling optics 20.

However, the end pumping technique may limit coupling efficiency, lower the fiber laser system robustness, due to the complex optics alignment and tight tolerances required, and also increase the system cost, due to the expensive optics used. The problem becomes even more severe when high power fiber amplification is required. The complex alignment and tight tolerances, along with the high power flux at the fiber input end, render this configuration complex, inefficient, expensive and very sensitive to environmental changes.

Solutions have been proposed to these problems in the prior art. For example, U.S. Pat. No. 5,999,673 to Samartsev et al. describes a coupling between a multi-mode optical fiber pigtail and a double-clad optical fiber, that is, a fiber that includes an inner (single-mode or multi-mode) core with a diameter of few microns, a first cladding (multi-mode), and a second cladding. Samartsev et al. attempt to transfer multi-mode light source power to an optical fiber along a non-coaxial direction.

The coupling in Samartsev et al. comprises a tapered circular pump-guiding multi-mode fiber between the double clad fiber's inner cladding and the pump source. The pump-guiding fiber is tapered and then fused to the double clad fiber's inner clad, where the fusion region contains substantially the whole tapered region of the pump-guiding fiber, and nothing else. However, the divergence angle of the pump-guiding fiber, αs, and that of the multi mode inner cladding part of the double clad fiber, αf, has to satisfy the following relation:

αf=k·αs

wherein k is a constant greater than 1.

There is an interest in using pump guiding fibers satisfying k<=1, since these pump guiding fibers can deliver more power than pump guiding fibers satisfying the k>1 condition, as in Samartsev et. al. Pump guiding fibers satisfying k<=1 have a higher numerical aperture than pump guiding fibers with k>1, and therefore, low brightness pump diode light with higher power can be efficiently coupled to these fibers, whereas with pump guiding fibers satisfying k>1, as in Samartsev et. al, the coupling efficiency is low.

Sintov in PCT application PCT/IL2004/000512 describes a method utilizing an attachment section of the two fibers composed of two sections, one being straight and the other tapered. This method allows the use of pump guiding fibers satisfying k>1, which in turn enables more pump power to be coupled with even higher efficiency than Samartsev et al.

In both attachment methods described and other methods as well, fusion techniques render the attachment process of the pump guiding fiber to the double clad fiber's inner clad complex, deform the mode pattern of both pump guiding fiber and double clad fiber's inner clad, which may result in low coupling efficiency. In addition fusion attachment techniques deform the double clad fiber doped core, due to the high temperature levels required. The high deformation probability has many implications on fiber lasers and amplifiers performance, such as preserving the beam quality and maintaining the polarization state of the amplified signal, especially when polarization-maintaining cores are involved.

There is therefore an interest in using non-fusion techniques for attaching pump-guiding fiber to a double clad fiber in both coupling methods described and other methods as well. These non-fusion techniques should keep the advantages of fusion splicing, such as high power delivery capabilities, strength and durability under hard environmental conditions. An example of a non-fusion technique is by implementing an optical adhesive as an optical intermediate material between the pump-guiding fiber and the double-clad fiber's inner clad, which has similar optical properties as the glass of which both said fibers are composed.

However, commonly used UV-cured or epoxy based optical adhesives, which may be used for attaching the pump-guiding fiber to the double clad fiber's inner clad have poor mechanical properties and low damage threshold. Therefore, the maximum allowed power that can be delivered through the above-described and other pump coupling techniques is in the range of only a few watts. Above this value, the optical adhesive is damaged and the coupling efficiency between the pump-guiding fiber and the double-clad fiber's inner-clad is jeopardized.

### SUMMARY OF THE INVENTION

The present invention seeks to provide a simple, efficient, rugged, and low cost side-coupling optical intermediate adhesion material to be implemented between a pump-guiding fiber and an active double clad fiber, for the implementation of side pumping of high power fiber lasers and amplifiers. The invention may comprise a pump-guiding fiber, optically side coupled to a double-clad fiber's inner clad, and employing a leaky guiding mode coupling from a pump guiding fiber to a receiving active double clad fiber through the intermediate material. The double clad fiber may be used to form a fiber laser or an optical amplifier. A sol-gel-derived material may be used as an intermediate adhesive between the two fibers, as is described more in detail herein below.

The use of sol-gel-derived materials in high power pump combiner for fiber lasers and amplifiers may reduce damage threshold of the side coupler, increase mechanical strength of the adhesion of the two fibers, and facilitate high power pump injection into the active fiber, without causing any deformation to the active fiber's core. The sol-gel is much more robust, less expensive, and more efficient and may scale side couplers to high powers than other optical adhesives like UV or epoxy based adhesives.

### BRIEF DESCRIPTION OF THE DRAWINGS

The present invention is herein described, by way of example only, with reference to the accompanying figures, wherein:

FIG. 1 is a simplified block diagram of a prior art end coupling in a high power fiber amplifier;

FIG. 2 is a simplified block diagram of a side coupling for a high power double clad fiber laser or amplifier, utilizing sol-gel-derived material as an intermediate material, in accordance with the prior art;

FIG. 3 is a simplified pictorial illustration of a tapered fiber used in the side coupling of FIG. 2, constructed and operative in accordance with an embodiment of the present invention;

FIG. 4 is a simplified cross-sectional illustration of a hexagonal double clad fiber used in the side coupling of FIG. 2, in accordance with an embodiment of the present invention; and

FIG. 5 is a simplified pictorial illustration of a twisted pre-tapered pump-guiding fiber core around the fed inner cladding of a double clad fiber, with an aim to create a side coupler by using sol-gel-derived material as an intermediate material in accordance with an embodiment of the present invention.

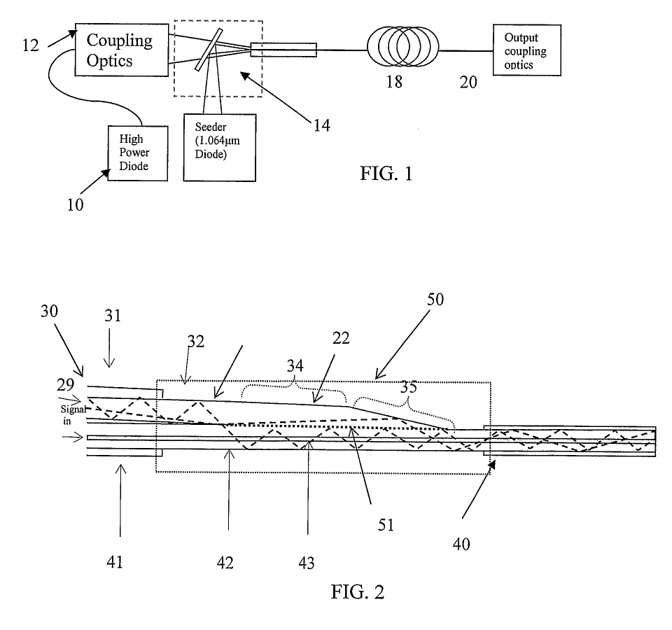

### DETAILED DESCRIPTION OF EMBODIMENTS

Reference is now made to FIG. 2, which illustrates a side coupling for a fiber laser or optical amplifier, such as a high power double clad fiber laser or amplifier, constructed and operative in accordance with an embodiment of a prior art invention (Sintov, PCT/IL2004/000512). The disclosures of all patents and literature mentioned herein are all incorporated herein by reference.

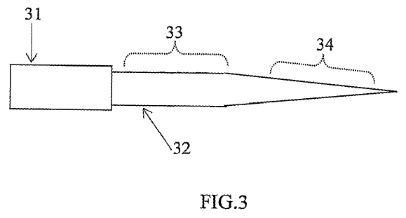

A pump-guiding fiber 30 may comprise a fiber cladding 31, a fiber core 32 and an attachment section 33. As seen in FIG. 3, the fiber core 32 is exposed by stripping the fiber cladding 31 along the attachment section required 33. The attachment section 33 may comprise a straight core section 34 and a tapered core section 35. The pump-guiding fiber 30 may be optically attached at one end thereof to a pump source 29, such as but not limited to, a semiconductor diode laser. The opposite end of pump-guiding fiber 30, is attached to an inner clad 42 of a receiving (also referred to as an active or amplifying) fiber 40, which may be double clad, through an attachment section 50. The attachment section 50 is comprised of both straight core section 34 and tapered core section 35 of the pump-guiding fiber 30, the inner clad 42 of the receiving fiber 40 and an intermediate sol-gel material 51, for achieving good mechanical adhesion as well as good optical contact between the pump-guiding fiber 30 and the receiving fiber's inner clad 42.

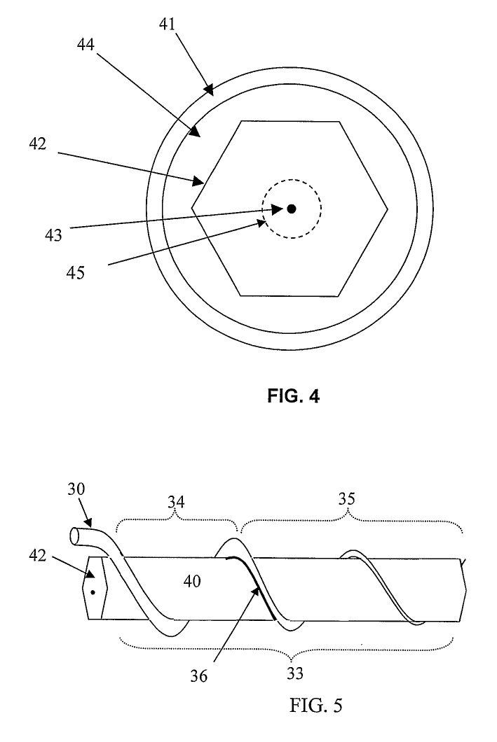

As seen in FIG. 4, the receiving fiber 40 may include, without limitation, a protective outer jacket 41, an outer clad 44, inner clad 42 and a doped core 43, which may comprise a rare-earth doped core, such as but not limited to, Yb³⁺ doped silica, Er³⁺ doped silica, Yb³⁺:Er³⁺ doped silica, Tm³⁺ doped silica and Ho³⁺:Tm³⁺ doped silica fibers. Additional clad layers 45 may be added between the doped core 43 and inner clad 42, creating a multiple clad fiber. The inner clad 42 of the receiving fiber 40 may be non-symmetrical, which may help to reduce or eliminate helical modes evolution, since these modes do not overlap with the doped core 43. The inner clad 42 may have a circular or noncircular symmetry shape, such as but not limited to, a rectangular, D-shape, hexagonal (this example being illustrated in FIG. 4), or any other shape

In the present invention, both the straight section 34 and the tapered section 35 of the pump-guiding fiber 30 are attached to the double clad fiber 40 by utilizing an adhesive intermediate sol-gel-derived material 51 whose refractive index should be closely identical to that of the two attached fibers.

In addition, in the present invention, the apparatus as described herein and illustrated in FIG. 2, may be coated with a low index optical material whose refractive index is lower than 1.4, for creating a rugged component, stable against hard environmental conditions. The low index feature of the encapsulating coating material is required for preserving the guiding properties of the apparatus illustrated in FIG. 2. In addition, the encapsulating coating forms a heat evacuating medium to the surrounding environment, when high powers should be delivered from the pump-guiding fiber 30 to the double clad fiber's inner clad 42.

In the present invention the interaction section 50 is composed of sol-gel-derived material 51. Sol-gel is a well-known technology for preparing glasses with excellent optical properties, at low temperature, below the glass melting point. Sol-gel processing involves the hydrolysis of a metal alkoxide, followed by cascade of condensation and poly-condensation reactions. The basic reactions of a silica sol-gel system undergoing concurrent hydrolysis and condensation are:

nSi(OR)₄+4nH₂O [symbol] nSi(OH)₄+4nROH [1]

nSi(OH)₄→nSiO₂+2nH₂O [2]

More detailed information pertaining to the chemistry of sol-gel processing can be found in several books and review articles:
L. C. Klein (ed.) Sol-Gel Technology For Thin Films, Performs, Electronics, and Specialty Shapes, Noyes, New Jersey, (1988).
J. Livage, M. Henry and C. Sanchez, Prog. Solid-State Chem., 18, 259 (1988).
C. J. Brinker and G. W. Scherer, Sol-Gel Science, Academic Press, San Diego, (1990).
L. L. Hench and J. K. West, Chem. Rev. 90, 61 (1990).
H. Schmidt, Mater. Res. Symp. Proc., 171, 3 (1990).
L. C. Klein, Sol-Gel Optics: Processing and Applications, Kluwer Academic Publishers, Boston, (1993).

A promising class of sol-gel-derived materials includes organic/inorganic hybrid materials which combine the merits of an inorganic glass and an organic polymer or organic dye. Applications of sol-gel organic/inorganic hybrid materials have been reported in wide range of research works and patents, for example:
D. Avnir, D. Levy and R. Reisfeld, J. Phys. Chem. 88, 5956 (1984).
E. J. A. Pope, M. Asami and J. D. Mackenzie, J. Mater. Res. 4, 1018 (1989).
Y. Haruvy, A. Heller and S. E. Webber, “Sol-Gel Preparation of Optically Clear Supported Thin-Film Glasses Embodying Laser Dyes—Novel Fast Method”, Chap. 28 in Proc. ACS Symp., 499, “Supramolecular Architecture: Synthetic Control in Thin Films and Solids”, T. Bein, Ed, ACS (1992).
Y. Haruvy and S. E. Webber, Electric field curing of polymers, U.S. Pat. No. 5,357,015 (1994).
P. N. Prasad, J. D. Bhawalkar, G. S. He, C. F. Zhao, R. Gvishi, G. E. Ruland, J. Zieba,
P. C. Cheng, S. J. Pan, Two-photon upconverting dyes and applications, U.S. patent application Ser. No. 08/712,143 (1996).
R. Gvishi, U. Narang, G. Ruland, D. N. Kumar and P. N. Prasad, Novel, Organically Doped, Sol-Gel-Derived Materials for Photonics: Multiphasic Nanostructured Composite Monoliths and Optical Fibers, Applied Organometallic Chemistry, Vol. 11, 107 (1997).

For example, one embodiment for implementing a pump combiner as described in FIG. 2 or other side coupling methods, may comprise a sol-gel-derived intermediate material 51 which may be a fast sol-gel. Fast sol-gel is a single-step method of preparing sol-gel glasses. In this case crack-free, highly transparent glasses are rapidly prepared in a matter of minutes from alkoxysilane and alkylalkoxysilane monomers. Variations of the precursor monomers allow flexibility in achieving desired polymer properties. A detailed description of the method is described in Haruvy et. al. U.S. Pat. No. 5,357,015 (1994) and the article
A. Gutina, Y. Haruvy, I. Gilath, E. Axelrod, N. Kozlovich, and Y. Feldman, J. Phys. Chem. B, 103(26), 5454-5458 (1999).

Another embodiment for implementing a pump combiner as described in FIG. 2 or other side coupling methods, may comprise a sol-gel-derived intermediate material 51, which may be other combinations of sol-gel-derived materials, capable of being fabricated into a thin film. These materials show promise for use in fiber and waveguide optics. Examples of other sol-gel methods through which a sol-gel-derived intermediate material 51 may be fabricated are presented in the following articles:
Y. Sorek, R. Reisfeld, I. Finkelstein and S. Ruschin, Appl. Phys. Lett., 66, 10 (1995).
R. Gvishi, G. Ruland, and P. N. Prasad, Optics Commun., 126, 66 (1996).
F. Del Monte, P. Cheben and C. P. Grover, J. D. Mackenzie, Journal of Sol-Gel Science and Technology, 15, 73 (1999).

Example in tests on an embodiment of the present invention employing a fast sol-gel-derived material as an intermediate material, a coupling efficiency of up to 93% was achieved between a pre-tapered circular pump-guiding hard clad coated fiber 30 of 200 μm, NA=0.4 core, and a double clad fiber with 400 μm, NA=0.36 hexagonal shaped inner clad. The overall attachment length 33 was 50 mm with a straight section 34 length of 42 mm and a tapered section 35 of 8 mm.

Another preferred method of attachment is shown in FIG. 5. In this method one may pre-taper the pump-guiding fiber 30 to the required straight 34 and tapered 35 sections lengths, and then twist the pump-guiding fiber 30 pre-tapered attachment sections 33 around the receiving fiber's 40 inner clad 42. Before twisting, both fibers may be immersed by a sol-gel-derived material 36. By twisting the fibers an optical contact is created between both fibers through the attachment section 33. By generating sufficient heat around both twisted fiber 30 and the receiving fiber 40, for curing the sol-gel-derived material, and simultaneously pull both fibers slightly to create better contact between them during attachment and curing, a high power pump coupler may be implemented after several hours of curing.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. Optical apparatus comprising:
a pump-guiding fiber (30) comprising a fiber cladding (31), a fiber core (32) and an attachment section (33), said attachment section (33) comprising a straight core section (34) and a tapered core section (35), said pump-guiding fiber (30) being optically attached at one end thereof to a pump source (29) and an opposite end of said pump-guiding fiber (30) being attached to an inner clad (42) of a receiving fiber (40) through an attachment section (50), said attachment section (50) comprising both said straight core section (34) and said tapered core section (35) of said pump-guiding fiber (30),
characterized in that both said straight core section (34) and said tapered core section (35) of said pump-guiding fiber (30) are attached to said receiving fiber (40) with an intermediate sol-gel material (51).

2. The optical apparatus according to claim 1, wherein said intermediate sol-gel material (51) achieves good mechanical adhesion and good optical contact between said pump-guiding fiber (30) and said receiving fiber's inner clad (42).

3. The optical apparatus according to claim 1, wherein a refractive index of said intermediate sol-gel material (51) is closely identical to that of said pump-guiding fiber (30) and said receiving fiber (40).

4. The optical apparatus according to claim 1, wherein said apparatus is coated with a low index optical material whose refractive index is lower than 1.4.

5. The optical apparatus according to claim 1, wherein said intermediate sol-gel material (51) comprises a fast sol-gel.

6. The optical apparatus according to claim 1, wherein said intermediate sol-gel material (51) comprises a sol-gel-derived intermediate material (51) capable of being fabricated into a thin film.

7. The optical apparatus according to claim 1, wherein a leaky guiding mode couples said pump-guiding fiber (30) to said receiving fiber (40) through said intermediate sol-gel material (51).

8. The optical apparatus according to claim 1, wherein said attachment section (33) is twisted around said inner clad (42), and before twisting, said pump-guiding fiber (30) and said receiving fiber (40) are immersed in said intermediate sol-gel material (36).
